(19) United States
(12) Patent Application Publication
(10) Pub. No.: US 2014/0172450 A1
(43) Pub. Date: Jun. 19, 2014

(54) AUTO CONFIGURATION OF A PERSONAL HEALTH MONITORING SYSTEM

(71) Applicant: Mark Repko, Indianapolis, IN (US)

(72) Inventor: Mark Repko, Indianapolis, IN (US)

(73) Assignee: GI Track, LLC, Indianapolis, IN (US)

(21) Appl. No.: 14/234,865

(22) PCT Filed: Aug. 1, 2011
(86) PCT No.: PCT/US2011/046162

§ 371 Date: Jan. 24, 2014

(51) Int. Cl. G06F 19/00; G06Q 10/10

(52) U.S. Cl. CPC G06F 19/322; G06Q 10/10
USPC 705/2

(57) ABSTRACT

The present disclosure relates to the field of personal health data tracking, and in particular to an automated system and method for configuring and managing a patient's account by a health care provider. One disclosed embodiment of the system includes a server and a remote interface for accessing the server through a network. The server may be a web server, and the remote interface may be a personal computer or smartphone device connected to the server via the Internet. The patient and the healthcare provider each connect to the server through their own remote interface. The healthcare provider completes an electronic form to identify the patient and select data elements for the patient to track. Upon completion of this form, a code is generated that the patient can use to automatically create a new patient account and configure its remote interface according to the healthcare provider's selections.

### FIELD

The present disclosure relates to a computer-based system for collecting and reporting on health-related information for individuals. In particular embodiments, the automated system allows association of information entered by a healthcare provider (such as information entered into an electronic prescription) with a particular patient's account, and which may allow access to the patient's account by the healthcare provider.

### BACKGROUND

Some medical data collection systems have enabled patients to track certain aspects of their medical conditions, such as those with diabetes tracking their blood sugar to manage the condition and adjust medication. For disorders where the particular disorder's causal relationships are unknown, or complex disorders that are likely to be affected by several independent parameters, however, achieving compliance with data collection requests has proven challenging. When compliance with data collection requests is inadequate, there is insufficient information with which to improve diagnosis and management of the patient's health condition. In addition, patients who work with multiple healthcare providers are unable to coordinate adequately between data collection requests by each. There is, therefore, a need for improved patient health data collection systems.

### BRIEF DESCRIPTION OF THE DRAWINGS

FIG. 1 is a block diagram of a computing system adapted for practitioner-configured medical data collection.

FIG. 2 is a schematic diagram of a computer for use in several places in the embodiment of FIG. 1.

FIG. 3 is a schematic diagram depicting healthcare provider input, patient input and creation of data records for use with the embodiment of FIG. 1.

FIG. 4 is a block diagram of a patient account record used in the embodiment of FIG. 1.

FIG. 5 is a flow diagram of a provider account record used in the embodiment of FIG. 1.

FIG. 6 is a flow diagram showing overriding of an existing data element configuration in the embodiment of FIG. 1.

FIG. 7 is a flow diagram showing amending of an existing data element configuration in the embodiment of FIG. 1.

FIG. 8 is a block diagram showing ignoring of a new data element configuration in the embodiment of FIG. 1.

### DESCRIPTION

For the purposes of promoting an understanding of the principles of the invention, reference will now be made to selected embodiments illustrated in the drawings and specific language will be used to describe the same. It will nevertheless be understood that no limitation of the scope of the invention is thereby intended; any alterations and further modifications of the described or illustrated embodiments, and any further applications of the principles of the invention as illustrated herein are contemplated as would normally occur to one skilled in the art to which the invention relates. At least one embodiment of the invention is shown in detail, although it will be apparent to those skilled in the relevant art that some features or some combinations of features may not be shown for the sake of clarity, and variations on specific implementation details will lie within the scope of the disclosure.

Any reference to “invention” within this document is a reference to an embodiment of a family of inventions, with no single embodiment including features that are necessarily included in all embodiments unless expressly stated. Further, although there may be references to “advantages” provided by some embodiments of the present invention, it must be understood that other embodiments may not include those same advantages, or may include different advantages when compared to other items that may or may not be in the prior art. Any advantages described herein are not to be construed as required by or limiting to any of the claims.

Generally, one form of the present invention is a data collection system that associates a medical service provider and at least one of the service provider's clients, such as a medical data collection system that associates a healthcare provider (e.g., a physician, a clinical trial manager, a designee of the aforementioned such as office staff, or other healthcare-related individuals as will be appreciated by one of ordinary skill) with at least one of the healthcare provider's patients (which in some embodiments includes participants in clinical trials). In one embodiment, the system helps physicians tailor a patient's interface with a data collection system to help the patient identify, track, and manage various data elements (e.g., actions, symptoms, and occurrences) related to the patient's disease, which may be chronic. These data elements can include, for example, disease symptoms, diet, and medication intake. Healthcare providers and patients use the system to create, manage, and maintain personal health information and communications, which may be integrated with or used in conjunction with personal health record (PHR) or electronic health record (EHR) information.

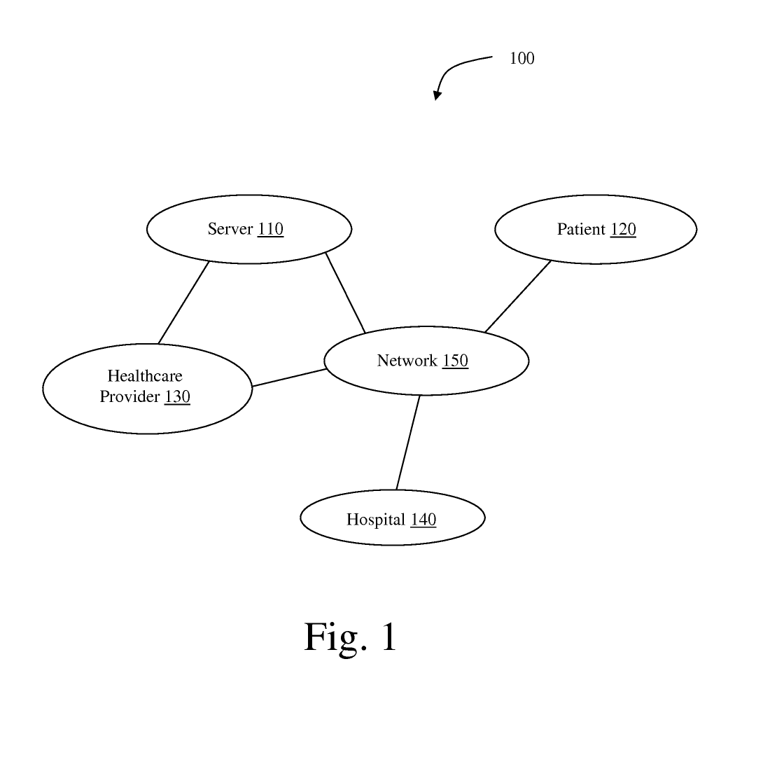

FIG. 1 illustrates various participants in system 100, all connected via a network 150 of computing devices, such as server 110, which may be of the form of a web server or other server as would be understood by one of ordinary skill in the art. Patient 120 and healthcare provider 130 each have data connections, either intermittent or permanent, to at least server 110. Some healthcare providers 130 have direct connections to hospitals 140 that use traditional electronic medical records (EMR) systems, and these systems might connect directly or indirectly to system 110 as well. In may embodiments, each computer communicates through network 150 with at least server 110. Server 110 may also have data connections to additional patients, additional healthcare providers, and additional hospitals as will be understood by one of ordinary skill in the art.

In one embodiment, patient 120 can communicate with server 110 through a smartphone or similar device as a convenient way for patient 120 to track the appropriate data elements, or fields, related to the patient's disease. In such embodiments, a healthcare provider 130 can recommend to patient 120 the use of a smartphone application or website to track specific data elements. Such a recommendation system allows healthcare provider 130 to select the data elements the patient will use for tracking and reporting purposes, in effect customizing the smartphone application or website for patient 120. It is also contemplated that the healthcare provider 130 can also communicate with server 110 through a smartphone or similar device.

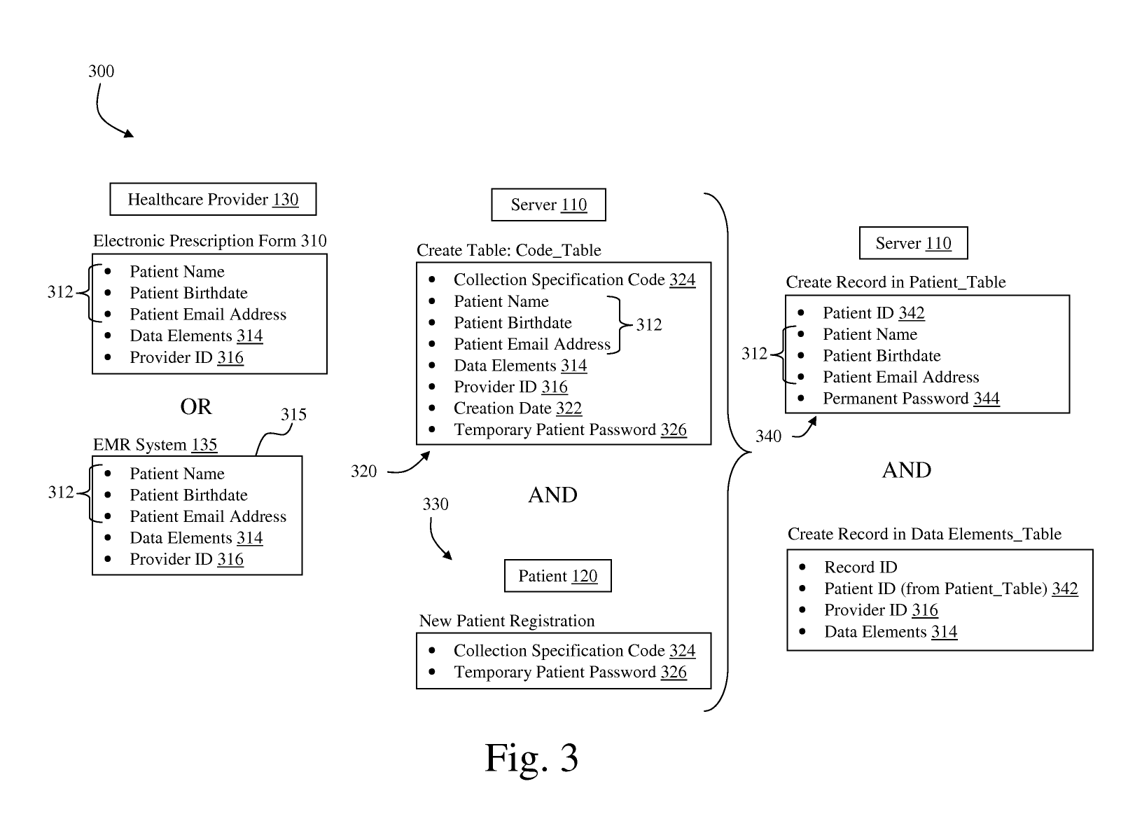

One use of a practitioner-configured data collection system according to one embodiment of the present invention is depicted in FIG. 3. In this example, the patient 120 has just been diagnosed with a chronic condition, and his healthcare provider 130 recommends tracking behaviors that may affect the condition and symptoms that result from the condition. The system 100 is generally configured to allow patients 120 to track some or all of a large list of occurrences and symptoms, such as temperature, blood sugar, weight, headache severity, cramping, bowel movements, administration of medication, food intake, and the like, though some of these may not be relevant to the particular condition of each given patient 120. The system 100 is, therefore, configured to prompt patients 120 for entry of data for a subset of the available types of data elements, as will be discussed further herein.

Referring again to the embodiment illustrated in FIG. 3, healthcare provider 130 signs into an account (e.g., a secure healthcare provider account) on server 110 and, after obtaining the identifying information from patient 120, fills out an electronic form 310. An electronic form (one example being depicted as form 310 in FIG. 3) contains one or more fields for patient identifying information 312 that uniquely identifies patient 120, which may include but is not necessarily limited to the name, email address, birthdate, social security number, address and telephone number(s) of patient 120.

Healthcare provider 130 may select appropriate data module(s) and data element(s) for patient 120 to track, for example, based on the patient's current health, disease state, perceived triggers (that is, triggers suspected by the healthcare provider 130 and/or the patient 120), and the like. For each data element individually, or all data elements collectively, healthcare provider 130 may specify the preferred or required frequency of data entry (e.g., as needed, daily, weekly, etc.) and the period of time over which patient 120 is to collect data (e.g., start date and end date, or duration). It should be appreciated that the interface for the healthcare provider 130 could include one or more menus of pre-configured options to automatically select appropriate data module(s) and/or data element(s) to simplify the selection process. Once the form is complete, healthcare provider 130 submits the form 310 to server 110.

Referring to item 320 of FIG. 3, server 110 stores the submitted data (patient identifying information 312 and data element selections 314) and a unique identifier 316 for healthcare provider 130 (“Provider ID 316” in FIG. 3, which in various embodiments may be generated by system 100, or selected by the healthcare provider 130, or taken from a registry of National Provider Identifiers) in a collection specification record 325 in a collection specification table, illustrated in FIG. 3, in some portion of a memory 220, such as a relational database. The creation date 322 of the collection specification record 325 and other accounting or auditing information may also be stored in the collection specification record 325.

The collection specification code 324 is created in different ways in various embodiments. In some embodiments, a healthcare provider 130 creates it arbitrarily. In others, server 110 creates it automatically by concatenating the sequence of characters that identifies provider 130 (either from their account on server 110, from a national provider registry, or other source), a sequence of characters that identifies the patient 120, and a sequence of characters that identifies the collection of data elements that the patient 120 is to track. In still others, server 110 creates a pseudorandom collection specification code 324 and associates it in a database with a record 320 comprising the information entered by healthcare provider 130. Then, after the code 324 is used (as will be discussed herein), this record is removed for security purposes. In yet other embodiments, collection specification code 324 is created and maintained in other ways that will occur to those skilled in the art.

In response to or as part of this submission, a collection specification code 324 and, if needed, a temporary patient password 326 are generated and/or submitted. In some embodiments, one or both items are generated by the healthcare provider 130 or their computer, and they are transmitted to server 110. In other embodiments, one or both items are generated by server 110 and transmitted to healthcare provider 130 and/or patient 120, such as by webpage interactions, email or SMS messaging. Healthcare provider 130 may also provide the information to patient 120 on a paper form.

The collection specification code 324 uniquely identifies the association between healthcare provider 130 and patient 120 and can also uniquely identify the data elements “prescribed” by healthcare provider 130 for patient 120, which can be stored in the relational database as data element selections 314 for future reference as described above. The collection specification code 324 and/or the temporary patient password 326 may expire within a certain, and potentially healthcare provider-selectable, time period.

In alternate embodiments, item 315 comprises an Electronic Medical Record (“EMR”) system used by healthcare provider 130 to electronically communicate information similar to that discussed above directly with the server 110. In still other embodiments, server 110 and item 315 are both integrated in an Electronic Medical Record (“EMR”) system used by healthcare provider 130.

After the interaction with healthcare provider 130, patient 120 connects to server 110 to set up the tracking that the healthcare provider 130 prescribed. Referring to item 330 of FIG. 3, in situations where patient 120 does not have a patient user account with system 100 (see “New Patient Registration” in item 330), server 110 will prompt patient 120 to set up an account and enter the collection specification code 324 and the temporary patient password 326, which may have been previously emailed to patient 120 or physically given to patient 120 in writing by healthcare provider 130. If the collection specification code 324 and temporary patient password 326 are both entered correctly, a new patient account is created for patient 120, as reflected in record 340 in a table of patients 120. In memory 220 of server 110, the account of patient 120 is associated with patient 120's username and patient ID 342, as well as data element selections 314. In some embodiments, patient 120 is then prompted to create a permanent password.

Upon successful creation of a new account, the information entered by healthcare provider 130 in the electronic form 310 (such as the patient identifying information 312 and healthcare provider 130's data element selections) is automatically loaded into patient 120's account by using the information stored with collection specification code 324. These embodiments simplify the registration process for patient 120.

In some situations, patient 120 will already have an account on server 110. In these cases, patient 120 logs into server 110, then enters collection specification code 324. Server 110 then associates that account of patient 120 with data element selections 314 that were stored in association with collection specification code 324.

In this exemplary embodiment, patient 120's interface with server 110 (e.g., patient 120's smartphone application and/or website account) is automatically configured to prompt patient 120 for the data element selections 314 selected by healthcare provider 130 and associated with the collection specification code 324. At this point, the list of data elements that the server 110 will use to prompt patient 120 for data entry will match those prescribed by healthcare provider 130. System 100 also links the accounts of patient 120 and healthcare provider 130 so that healthcare provider 130 is able to access data entries of patient 120 via, for example, a secure account, for review and for generating reports.

In some embodiments, patient 120's ongoing data entries are subject to automatic monitoring by server 110 to create automatic alerts as requested by patient 120 and/or healthcare provider 130. In another alternative, healthcare provider 130 can change the selection of recommended data elements that appear on patient 120's interface. In other embodiments, the collection specification code 324 automatically triggers creation of a private messaging connection between healthcare provider 130 and patient 120, thereby enabling private messaging between patient 120 and healthcare provider 130 through the system 100. Still further, data entered by patient 120 can be uploaded to an EMR system of healthcare provider 130, and patient 120 can download his or her medical record from the EMR system of healthcare provider 130 to facilitate creation of a self-managed EMR.

Patient 120 can have multiple collection specification codes 324 associated with his or her account. This allows patient 120 to track data element recommendations from multiple healthcare providers, eliminating duplication and maintaining a consistent user interface for all.

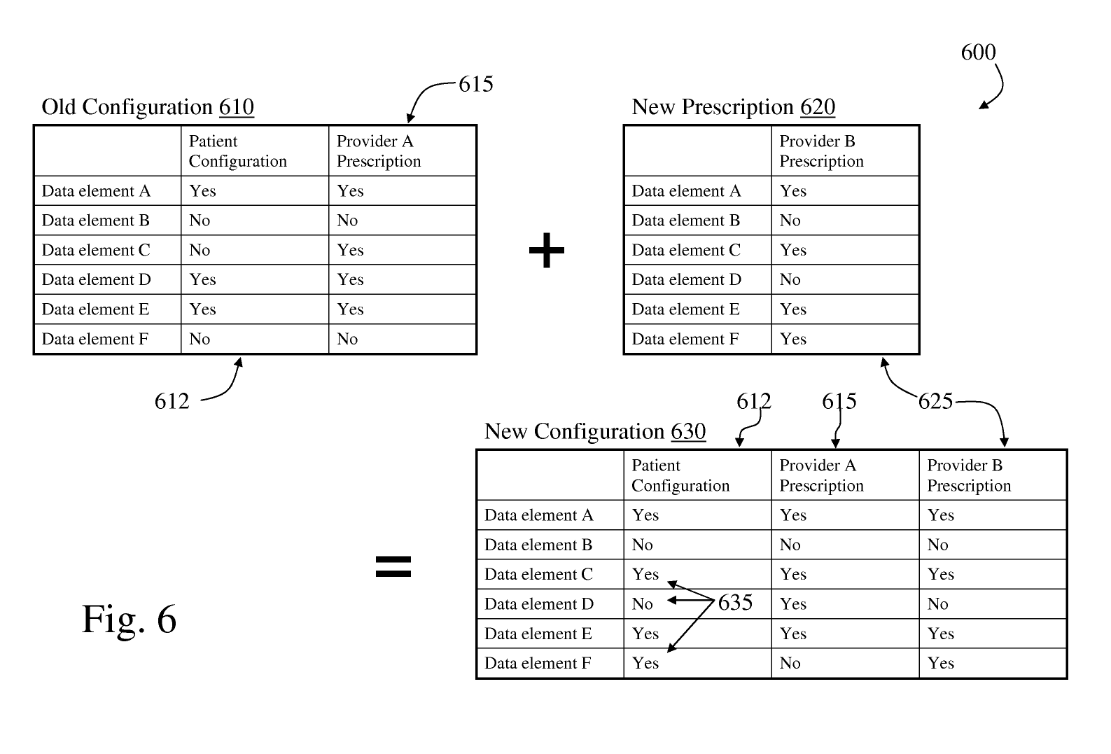

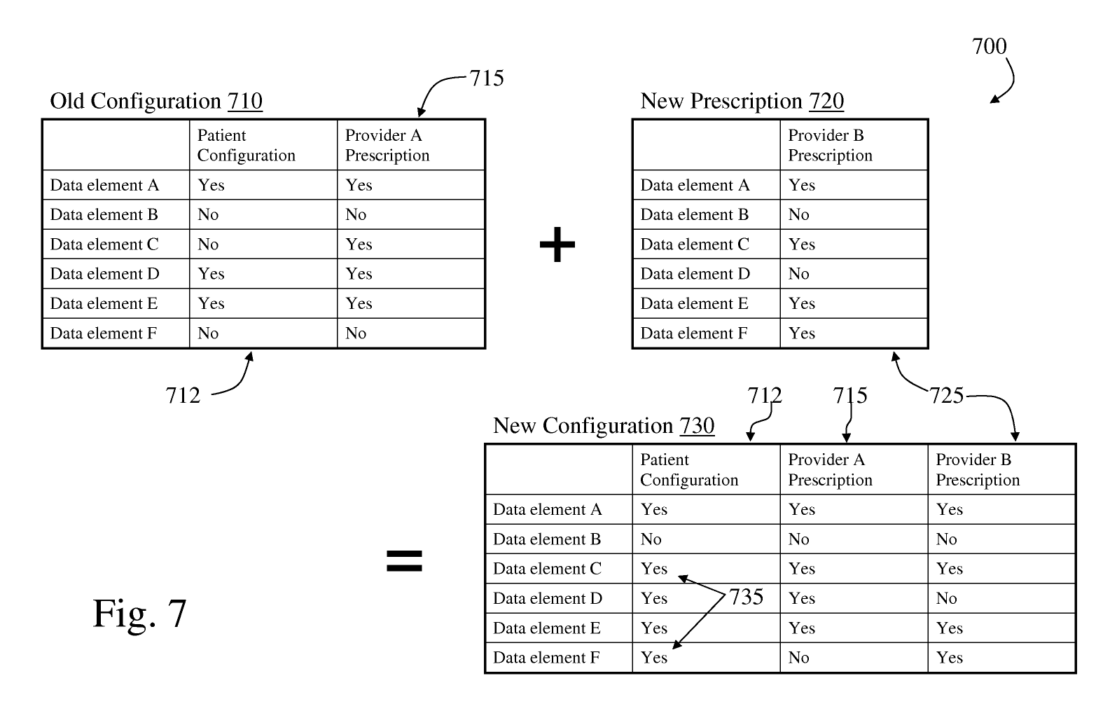

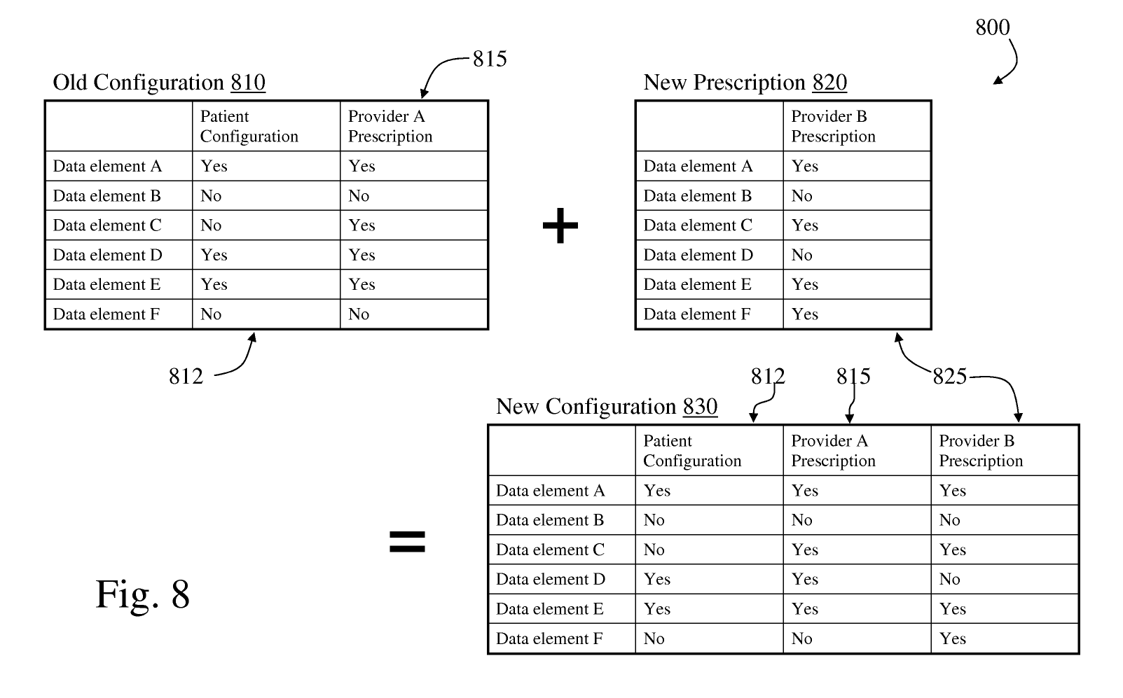

In situations where patient 120 already has a user account (see “Existing Patient Account” in item 330), patient 120 can add a new collection specification code 324 (for example, from the new healthcare provider 130) through patient 120's interface to system 100. Here, patient 120 is given an option to:
a) override his or her current data element selections with the new healthcare provider-selected data element selections 314 associated with the new collection specification code 324 (see FIG. 6, discussed below);
b) amend his or her current data element selections by adding the new healthcare provider-selected data element selections 314 associated with the new collection specification code 324 (see FIG. 7, discussed below); or
c) ignore the new healthcare provider-selected data element selections 314 associated with the new collection specification code 324 (see FIG. 8, discussed below), leaving his or her data element selections as they were.
   If patient 120 chooses to override or amend his or her current data element selections, his or her interface (e.g., smartphone application and/or website account) will be automatically configured to include the data elements selected by healthcare provider 130 and associated with the collection specification code 324.

For example, a situation in which the patient 120 elects to override an earlier selection of data elements is illustrated in FIG. 6. That process 600 begins with the existing (“old”) configuration 610, in which the first provider 130, “Provider A,” had given the data collection “prescription” 615 for the patient to collect data for data elements A, C, D, and E. The patient had elected not to collect data element C, yielding configuration 612 in old configuration 610. A second provider 130, “Provider B,” gave this patient 120 a different data collection prescription 625, and patient 120 elected to overwrite the existing configuration 612 with the new configuration 625. The result, new configuration 630, includes changed configuration selections 635 inpatient configuration 612.

In another example, patient 120 elects to merge an existing configuration with a new data collection “prescription,” as illustrated in FIG. 7. Existing patient configuration 712 was based on data collection prescription 715 from Provider A, together stored as old configuration 710. New prescription 720 includes provider be prescription 725, which patient 120 chooses to adopt without removing the existing data element selections in patient configuration 712. New configuration 730 includes an updated patient configuration 712 (with changed data element selections 735), retaining a record of data collection prescriptions 715 (from Provider A) and 725 (from Provider B).

In other situations, patient 120 may wish to ignore the data element selections made by a new provider and entered with a new collection specification code 324, as illustrated in FIG. 8. As in the other examples, old configuration 810 comprises an earlier data collection prescription 815 from “Provider A” and slightly adapted configuration 812. Though new prescription 820 from “Provider B” indicates that additional data elements should be added to the patient's collection routine, patient 120 has elected to ignore that recommendation. New configuration 830, therefore, reflects the same patient configuration 812 as in the old configuration 810. Still, the system maintains a record of the data collection prescriptions 815 (from Provider A) and 825 (from Provider B) for future reference.

Once the data elements from the data collection prescription are added, patient 120's ongoing data entries are made accessible to both healthcare providers 130 via, for example, the secure account of each healthcare provider 130. This provides that healthcare provider 130 the ability to review/analyze the data entered by patient 120 for the data elements in that provider's data collection prescription, and to generate reports on that data. Patient 120's ongoing data entries can also be subject to automatic monitoring and reporting by the server 110 to create automatic alerts for the patient 120 or a healthcare provider 130, as either of them may request. Healthcare provider 130 may also be able to change the recommended data elements, which in some embodiments will show up in patient 120's control panel. In other embodiments, the changed selection of data elements will appear as a suggestion that patient 120 can accept or reject. As mentioned above, private messaging can also be enabled between patient 120 and healthcare provider 130. In alternate embodiments, patient 120's data can be uploaded to healthcare provider 130's EMR system and patient 120 can download patient 120's complete medical record from healthcare provider 130's EMR system to create a self-managed EMR.

In some embodiments where patient 120 can override healthcare provider 130's data element selections, system 100 maintains a record of healthcare provider 130's original selection of data elements. As an example, healthcare provider 130's selections for data elements can be stored in a relational database in memory 220 and displayed in patient 120's control panel for reference. In addition, a comparison of patient 120's ongoing data entries to data elements selected by healthcare provider 130 can be made to help assess patient 120's compliance with healthcare provider 130's “prescription” for data entry. Such a compliance assessment can be made for each of multiple patients connected to server 110, displaying a compliance rating or score to healthcare provider 130, or any other entity as approved by patient 120.

In one embodiment, the collection specification code 324 is an alphanumeric code, for example a nine (9)-character alphanumeric code that is generated by healthcare provider 130 or one of healthcare provider 130's designates. A first set of characters (e.g., the first five (5) characters) may comprise a unique ID for provider 130. A second set of characters (e.g., the last four (4) characters) of the collection specification code 324 may be randomly generated and correspond to the recommended data elements healthcare provider 130 has established for patient 120. In some embodiments, healthcare provider 130 is the only party authorized to generate a collection specification code 324.

In other embodiments, the collection specification code 324 is pseudorandomly generated by server 110 and encoded in an alphabet of easily distinguishable symbols. For example, neither the number “0” nor the capital or lowercase letter “O” are used because they are easily confused. In some of these embodiments, no part of the collection specification code 324 is directly related to healthcare provider 130, patient 120, or any health-related information of patient 120. This arrangement improves security at the expense of convenience to healthcare provider 130 and their staff.

Healthcare provider 130's unique identifier (Provider ID 316) in some embodiments is generated upon successful creation of a provider account. In one embodiment, healthcare provider 130 is assigned a randomly generated and unique alphanumeric code (e.g., a randomly generated and unique five (5)-character code).

The collection specification code 324 and the Provider ID 316 may include, but are not limited to, capital and lowercase letters (generally excluding letter ‘o’), numerals one through nine (generally excluding zero), and various symbols, the more common ones being printable ASCII symbols. In certain embodiments, the order of letters and/or numerals does not matter, and the letters and/or numerals are allowed to repeat. In other embodiments, the first character of a Provider ID 316 is always made to be a capital letter.

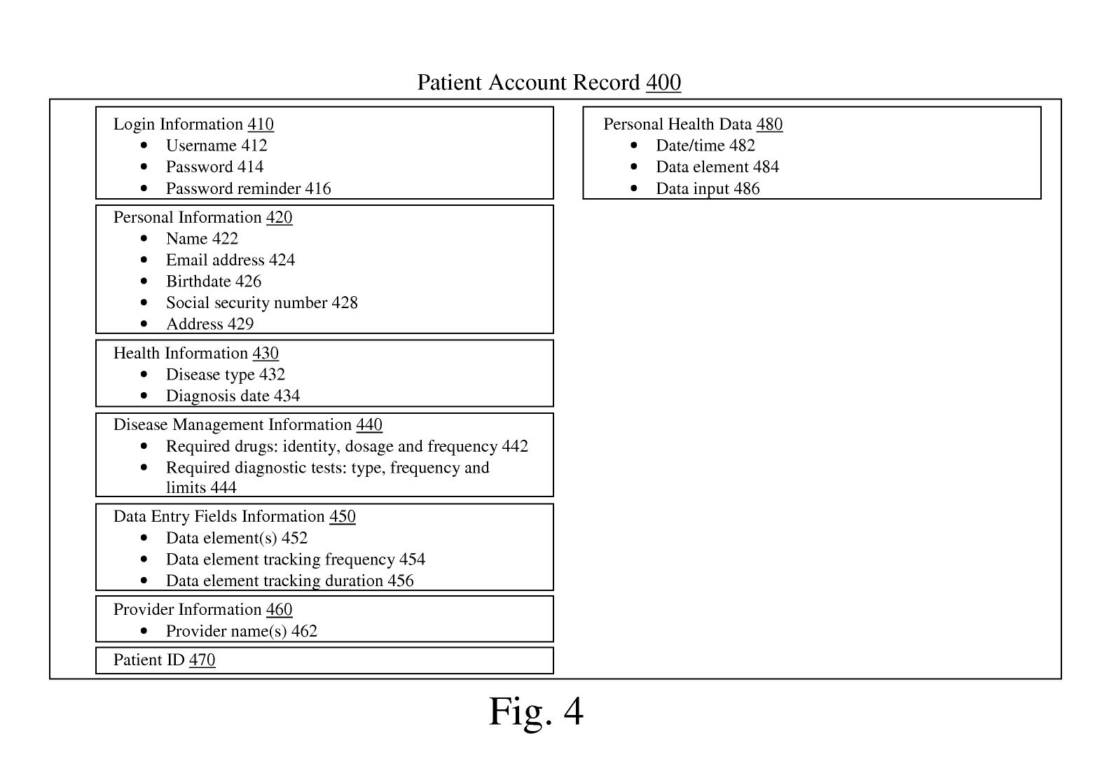

Once a patient 120 has an account in system 100, server 110 maintains a patient account record 400 for that patient 120 as illustrated in FIG. 4. Patient account record 400 stores login information 410, which, in this embodiment, includes a username 412, password (or password hash) 414, and password reminder 416 for patient 120. Patient account record 400 also stores personal information 420 for patient 120, including name 422, email address 424, birthdate 426, social security number 428, and address 429. Health information 430 is typically, but preferably not exclusively, entered by healthcare provider 130, and includes each disease type 432 and the diagnosis date 434 for that disease with which patient 130 has been diagnosed. Patient account record 400 also includes disease management information 440, such as the identity, dosage, and frequency of medications 442 and the type, frequency, and limits of diagnostic tests 444 that the patient 120 has taken or will take to manage that/those diseases. It also stores the provider information 460, including provider names 462, to which the patient's account is connected, as well as a unique Patient ID 470.

The data elements (here, “data entry fields”) that the patient 120 is to be presented for data entry are stored as information collection 450. For each data element 452, data entry fields information 450 stores the prescribed tracking frequency 454 and tracking duration 456 (for example, start and end dates, or “indefinitely”). When the patient 120 enters data for those data elements, those entries are stored as personal health data 480, including the date and time 482 of the entry, the data element 484 that was entered, and the data itself 486 that was entered. Reporting, monitoring, and compliance evaluation, for example, draw from these portions of patient account record 400.

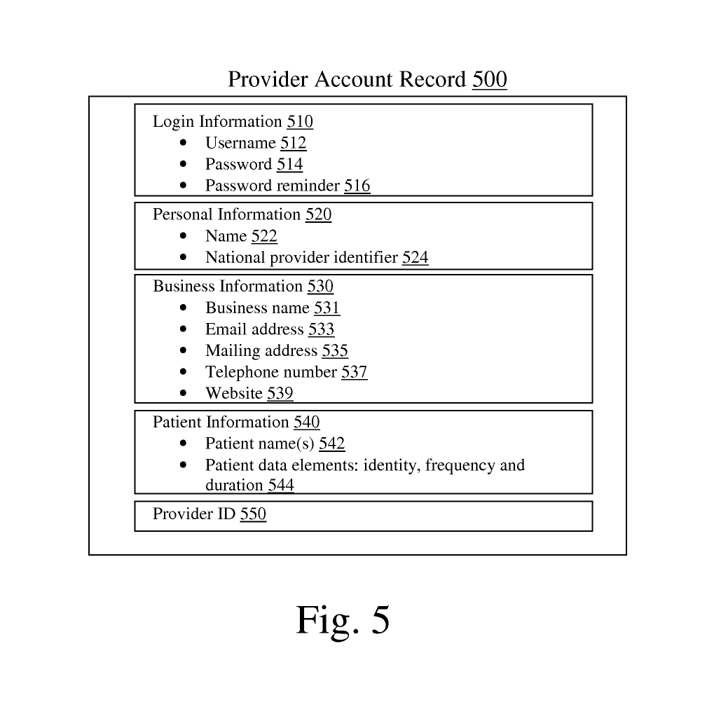

FIG. 5 illustrates a provider account record 500 that is used for healthcare providers 130 in some embodiments of system 100. Provider account record 500 includes login information 510 for the system, including username 512, password (or password hash) 514, and a password reminder 516. The provider's personal information 520 includes their name 522 and national provider identifier 524, used in some embodiments to create collection specification codes. Business information 530 for provider 130 includes their business name 531, email address 531, email address 533, mailing address 535, telephone number 537, and website 539, while Provider ID 550 is a unique identifier for provider 130 for use in system 100.

In this embodiment, provider account record 500 also includes patient information 540 for patients 120 who are associated with healthcare provider 130. Patient information 540 comprises patient names 542 and information 544 about data elements (their identity, frequency of prescribed input, and duration over which the input should continue) the patient is expected to enter. In some embodiments, this information is efficiently factored and associated by reference to data stored in one or more tables that represent patient health data 480 in association with patient account record 400.

In various embodiments, web portals that patients 120 and healthcare providers 130 use to communicate with server 110 are web application servers, such as those built on Apache, J2EE, Zend, Zope, and other application servers as will occur to those skilled in the art. Similarly, back office server systems may also be used, such as those implemented as J2EE modules, and back office repositories may be implemented in monolithic and/or distributed databases, such as those provided by the MySQL (http://www.mysql.com) or PostgreSQL (http://www.postgresql.org) open source projects, or Oracle Database 11g Release 2 (published by Oracle Corporation, 500 Oracle Parkway, Redwood Shores, Calif. 94065) or the DB2 database, published by IBM. A variety of other application servers and database systems may be used as will occur to those skilled in the art.

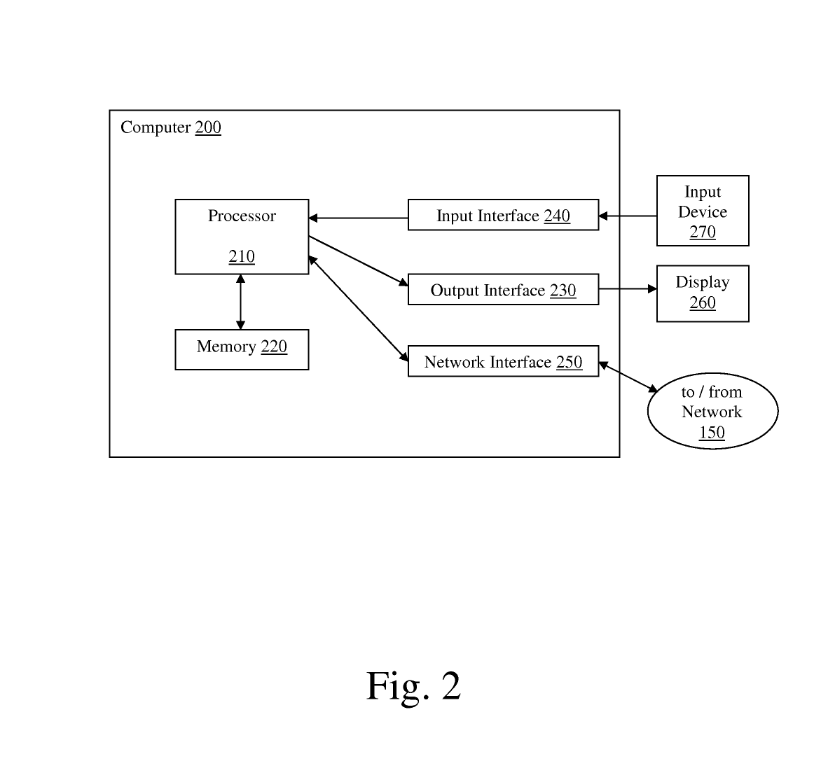

The computers used as servers, clients, resources, interface components, and the like for the various embodiments described herein generally take the form shown in FIG. 2. Computer 200, as this example will generically be referred to, includes processor 210 in communication with memory 220, output interface 230, input interface 240, and network interface 250. Power, ground, clock, and other signals and circuitry are omitted for clarity, but will be understood and easily implemented by those skilled in the art.

With continuing reference to FIG. 2, network interface 250 in this embodiment connects computer 200 to a data network (such as a direct or indirect connection to server 110) for communication of data between computer 200 and other devices attached to the network. Input interface 240 manages communication between processor 210 and one or more input devices 270, for example, pushbuttons, UARTs, IR and/or RF receivers or transceivers, decoders, or other devices, as well as traditional keyboard and mouse devices. Output interface 230 provides a video signal to display 260, and may provide signals to one or more additional output devices such as LEDs, LCDs, or audio output devices, or a combination of these and other output devices and techniques as will occur to those skilled in the art.

Processor 210 in some embodiments is a microcontroller or general purpose microprocessor that reads its program from memory 220. Processor 210 may be comprised of one or more components configured as a single unit. Alternatively, when of a multi-component form, processor 210 may have one or more components located remotely relative to the others. One or more components of processor 210 may be of the electronic variety including digital circuitry, analog circuitry, or both. In one embodiment, processor 210 is of a conventional, integrated circuit microprocessor arrangement, such as one or more CORE 2 QUAD processors from INTEL Corporation of 2200 Mission College Boulevard, Santa Clara, Calif. 95052, USA, or ATHLON or PHENOM processors from Advanced Micro Devices, One AMD Place, Sunnyvale, Calif. 94088, USA, or POWER6 processors from IBM Corporation, 1 New Orchard Road, Armonk, N.Y. 10504, USA. In alternative embodiments, one or more application-specific integrated circuits (ASICs), reduced instruction-set computing (RISC) processors, general-purpose microprocessors, programmable logic arrays, or other devices may be used alone or in combination as will occur to those skilled in the art.

Likewise, memory 220 in various embodiments includes one or more types such as solid-state electronic memory, magnetic memory, or optical memory, just to name a few. By way of non-limiting example, memory 220 can include solid-state electronic Random Access Memory (RAM), Sequentially Accessible Memory (SAM) (such as the First-In, First-Out (FIFO) variety or the Last-In First-Out (LIFO) variety), Programmable Read-Only Memory (PROM), Electrically Programmable Read-Only Memory (EPROM), or Electrically Erasable Programmable Read-Only Memory (EEPROM); an optical disc memory (such as a recordable, rewritable, or read-only DVD or CD-ROM); a magnetically encoded hard drive, floppy disk, tape, or cartridge medium; or a plurality and/or combination of these memory types. Also, memory 220 is volatile, nonvolatile, or a hybrid combination of volatile and nonvolatile varieties.

While illustrated examples, representative embodiments and specific forms of the invention have been illustrated and described in detail in the drawings and foregoing description, the same is to be considered as illustrative and not restrictive or limiting. The description of particular features in one embodiment does not imply that those particular features are necessarily limited to that one embodiment. Features of one embodiment may be used in combination with features of other embodiments as would be understood by one of ordinary skill in the art, whether or not explicitly described as such. Exemplary embodiments have been shown and described, and all changes and modifications that come within the spirit of the invention are desired to be protected.

What is claimed is:

1. A system for managing healthcare information, comprising a processor and a memory in communication with the processor, the memory storing programming instructions executable by the processor to:
accept a first input, the first input
being from a first healthcare provider,
including patient-identifying information for a patient, and
including a first set of one or more prescribed data elements for the patient to track;
store a first code and associate the first code with at least a portion of the first input;
after accepting the first input, accept a second input, the second input being from the patient and including the first code; and
responsively to the second input, associate the first healthcare provider and the patient in a database.

2. The system of claim 1, wherein the programming instructions are further executable by the processor to configure a user interface for the patient based on the first set of data elements prescribed by the first healthcare provider for the patient.

3. The system of claim 2, wherein the user interface prompts the patient for repeated data entry, and the fields are selected based on the first set of data elements prescribed by the healthcare provider for the patient.

4. The system of claim 3, wherein the programming instructions are further executable by the processor to:
accept a third input from the patient, the third input indicating the selection of one or more additional data elements; and
as a function of the third input, configure the user interface to prompt for input for the one or more additional data elements.

5. The system of claim 3, wherein the programming instructions are further executable by the processor to:
accept a third input from the patient, the third input indicating the selection of one or more of the prescribed data elements; and
as a function of the third input, configure the user interface not to prompt for input for the one or more additional data elements.

6. The system of claim 3, wherein the programming instructions are further executable by the processor to:
accept a third input, the third input
being from a second healthcare provider,
including patient-identifying information for the patient, and
including a second set of one or more prescribed data elements for the patient to track;
store a second code and associate the second code with at least a portion of the third input;
after accepting the third input, accept a fourth input, the fourth input being from the patient and including the second code;
responsively to the fourth input, associate the second healthcare provider and the patient in a database; and
present prompts to the patient for data entry into interface fields selected based on the prescribed data elements in at least one of:
the first input and not the third input,
the third input and not the first input, and
the first and third inputs.

7. The system of claim 1, wherein a portion of the code is an identifier for the healthcare provider.

8. The system of claim 1, wherein a portion of the code is an identifier for the patient.

9. The system of claim 1, wherein a portion of the code is an identifier for the prescribed data elements.

10. The system of claim 1, wherein:
no part of the code is an identifier for the healthcare provider; and
no part of the code is an identifier for the patient.

11. The system of claim 10, wherein the database stores a relationship between the code, patient, healthcare provider, and prescribed data elements.

12. The system of claim 11, wherein the database removes the relationship between the code and the patient from the database after associating the healthcare provider and the patient.

13. A system for managing health information, comprising a processor and a memory in communication with the processor, the memory storing programming instructions executable by the processor to:
accept selection input from a healthcare provider, the selection input indicating a patient and at least one data element;
accept input of a code from a patient; and
responsively to accepting input of the code, manage a database to associate the at least one data element with an account of the patient.

14. The system of claim 13, wherein the programming instructions are further executable, responsively to accepting input of the code, to manage the database to associate the healthcare provider with the patient.

15. The system of claim 13, wherein the programming instructions are further executable, responsively to accepting input of the code, to configure a user interface presented to the patient for repeated recording of data in the at least one data element.

16. The system of claim 15, wherein the programming instructions are further executable to:
accept additional input from the patient indicating a selection of additional data elements; and
further presenting the user interface to the patient for repeated recording of data in the selected additional data elements.

17. A method for managing health information, comprising the acts of:
accepting input from a first healthcare provider into a memory that is in communication with the processor, where the input from the first healthcare provider comprises data elements prescribed for the patient and a first code;
accepting input from the patient into the memory, the patient input including the first code; and
associating the patient with the first healthcare provider in the memory using the processor, if the input from the patient correlates with the first code entered by the first healthcare provider.

18. The method of claim 17, further comprising the acts of:
presenting a user interface to the patient, where the user interface comprises prompts for data entry related to the prescribed data elements; and
accepting input from the patient responsive to the prompts through the user interface.

19. The method of claim 18, further comprising the acts of:
adapting the user interface prompts based on a selection of one or more data elements from a collection of possible data element fields; and
wherein the input accepted through the user interface comprises patient entry of data in the selected data element fields.

20. The method of claim 19, further comprising the acts of:
presenting data entry fields to the patient for entry of health-related data, where the data elements are selected by the healthcare provider; and
collecting the health-related data and storing it in the memory in association with the patient.

21. The method of claim 20, the method further comprising the acts of:
accepting input from a second healthcare provider into a memory that is in communication with the processor, where the input from the second healthcare provider comprises data elements prescribed for the patient and a second code;
accepting input from the patient into the memory, the patient input including the second code; and
associating the patient with the second healthcare provider in the memory using the processor, if the input from the patient correlates with the second code entered by the second healthcare provider.
